(19) United States
(12) Patent Application Publication
(10) Pub. No.: US 2015/0276586 A1
(43) Pub. Date: Oct. 1, 2015

(54) MERCURY VAPOR TRACE DETECTION USING PRE-EXCITATION CAVITY RING DOWN SPECTROSCOPY

(71) Applicant: University of Virginia Patent Foundation, Charlottesville, VA (US)

(72) Inventor: Kevin K. Lehmann, Crozet, VA (US)

(21) Appl. No.: 14/434,598

(22) PCT Filed: Oct. 11, 2013
(86) PCT No.: PCT/US13/64648

§ 371 Date: Apr. 9, 2015

Related U.S. Application Data
(60) Provisional application No. 61/713,074, filed on Oct. 12, 2012.

(51) Int. Cl. G01N 21/31; G01N 21/39

(52) U.S. Cl. CPC G01N 21/3103; G01N 21/39; G01N 2201/0612

(57) ABSTRACT

Apparatus and techniques can include optically exciting an analyte gas in an optically-resonant cavity using optical energy having a first range of wavelengths including a wavelength specified to provide a metastable excited state of a species to be probed in the analyte gas. Such optical excitation can be referred to as “pre-excitation.” Optical energy having a second range of wavelengths can be coupled to the optically resonant cavity, including a wavelength specified to be absorbed using the metastable excited state of the species to be probed in the analyte gas, and outcoupled to a detector. One or more of a decay rate or a decay duration (e.g., a “ring-down” characteristic) can be monitored, such as to determine a presence or quantity of the species in the analyte gas. Such pre-excitation and probing can be referred to as Pre-Excitation Cavity Ring-Down Spectroscopy (PE-CRDS), such as for trace detection of mercury.

### CLAIM OF PRIORITY

Benefit of priority is hereby claimed to U.S. Provisional Patent Application Ser. No. 61/713,074, titled “TRACE MERCURY VAPOR DETECTOR BASED UPON PRE-EXCITATION CAVITY RING-DOWN SPECTROSCOPY,” filed on Oct. 12, 2012 (Attorney Docket No. 01975-01), which is hereby incorporated by reference herein in its entirety.

### BACKGROUND

Contamination by heavy metals remains a persistent environmental problem, due in part to the toxicity of such heavy metals, even at extremely low doses. Mercury (Hg) contamination is of particular concern due to the diffuse release of mercury in large scale associated with activities such as coal burning for power generation, both in the United States and in other major industrialized nations such as within Europe and Asia. The Unites States Environmental Protection Agency (EPA) has announced regulations requiring monitoring and removal of mercury from stack emissions. An enabling technology for enforcement of such regulations is apparatus for continuous emission monitoring (CEM). CEM techniques can include measurement of trace concentrations of compounds such as mercury, both in mercury's elemental form (Hg) or in oxidized form (e.g., Hg²⁺, mostly existing as HgCl₂ and HgO).

### OVERVIEW

The present inventor has recognized, among other things, that a reliable, sensitive, and specific instrument is needed to monitor mercury emissions at minute or trace levels. According to various examples, such monitoring can be used to validate mercury reduction approaches, to guide development of new technologies for mercury reduction, to provide sustained monitoring for verification of emissions standards, or for process control.

Continuous-Wave Cavity Ring-Down Spectroscopy (cw-CRDS) can be used for trace detection of gases, including for environmental monitoring. However, most existing applications of this technology have used optical energy in the visible and near-infrared range of the electromagnetic spectrum to excite a high-finesse optical cavity structure. In such a range of wavelengths, very low loss mirrors and narrow linewidth tunable continuous wave (cw) lasers are available. Improved broadly tunable cw-lasers in the mid-IR are also available. In the mid-IR, many molecules have their most intense fundamental vibrational transitions, and mid-IR cw-CRDS instruments have been used to probe such vibrational transitions. These techniques have broadened the range of molecules that can be detected with high sensitivity and selectivity by the CRDS method.

However, individual atoms do not have such vibrational transitions, and most only have absorption transitions from the ground state in the ultraviolet (UV) region of the electromagnetic spectrum, such as corresponding to free space wavelengths less than about 300 nanometers. This consideration also applies to most homo-nuclear diatomic molecules, such as molecular hydrogen, H₂ and molecular nitrogen, N₂. For those diatomic molecules having longer wavelength transitions, such as molecular oxygen, O₂, these longer wavelength transitions are weak and thus provide poor sensitivity when detecting trace levels.

In the example of Hg vapor, a longest wavelength absorption from the ground state is at about 254 nm. Such short wavelengths can be problematic for cw-CRDS-based detection. Only limited laser sources are available having output at such a short wavelength, and those only provide low power and often very high cost. Also, high reflectivity mirrors available in the mid-ultraviolet are much inferior to those available in the visible and near-IR ranges of the electromagnetic spectrum. Both these reduce the sensitivity of cw-CRDS when performed using UV optical transitions to probe analyte concentrations. Other drawbacks of gas phase absorption measurements at 254 nm are poor sensitivity due to small effective absorption path length, significantly higher Rayleigh scattering, and the many sources of interference at 254 nm, such as ozone, which absorbs strongly at this wavelength and can lead to “false positive” readings.

The present inventor has recognized, among other things, that most atoms and many simple molecules have long-lived metastable excited electronic states. When such atoms or molecules are excited using photonic excitation, electrical discharge, or using other techniques, a substantial steady-state concentration of excited atoms accumulates at such metastable energy levels. Usually, there are very strong electronic transitions from these metastable levels in the visible and near-IR spectral range, where cw-CRDS has maximum sensitivity. For example, such an approach of pre-excitation (e.g., optical excitation to induce a population of atoms at the metastable excitation level), and then probing using visible light can provide capability of detection on the order of parts per trillion level of gas concentration by volume. In one aspect, mercury vapor can be monitored and measured using absorption spectroscopy of Hg atoms excited into a long-lived excited metastable atomic state (the lowest ³P₀ state). The absorption can be observed using cavity ring-down spectroscopy including using a probing energy in the visible range of the spectrum at about 404.66 nm, for example.

Apparatus and techniques described herein can include optically exciting an analyte gas in an optically-resonant cavity using optical energy having a first range of wavelengths including a wavelength specified to provide a metastable excited state of a species to be probed in the analyte gas. Such optical excitation can be referred to as “pre-excitation.” Optical energy having a second range of wavelengths can be coupled to the optically resonant cavity, including a wavelength specified to be absorbed using the metastable excited state of the species to be probed in the analyte gas, and outcoupled to a detector. One or more of a decay rate or a decay duration (e.g., a “ring-down” characteristic) can be monitored, such as to determine a presence or quantity of the species in the analyte gas. Such pre-excitation and probing can be referred to as Pre-Excitation Cavity Ring-Down Spectroscopy (PE-CRDS), such as for use in detection of mercury vapor at trace levels.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 illustrates generally an example of an energy level diagram for various isotopic forms of mercury (Hg).

FIGS. 2A through 2C illustrates generally shapes of emission spectra of mercury centered around 253.7 nanometers (nm) that can be obtained from a discharge, such as from a reversed lamp in FIGS. 2A and 2B, and an un-reversed lamp in FIG. 2C.

FIG. 3 illustrates generally a shape of an absorption spectrum of mercury showing a range of peaks from about 404.65 nanometers (nm) to about 404.67 nanometers (nm).

FIG. 4 illustrates generally an apparatus, such as a portion of a system, that can include an optical source, a sample cell assembly including a source of optical excitation, and a detector.

FIG. 5 illustrates generally an illustrative example of a portion of a sample cell assembly that can include a helical optical energy source or other configuration, such as circumferentially located around a perimeter of an optically-transparent portion of the sample cell.

FIGS. 6A through 6C illustrate generally illustrative examples of cross-sectional views of a portion of a sample cell assembly that can include one or more linearly-arranged optical energy sources.

FIG. 7 illustrates generally a technique, such as a method, that can include optically exciting a species included in an analyte gas located in a resonant cavity, and probing the analyte gas to determine a presence or quantity of the species.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

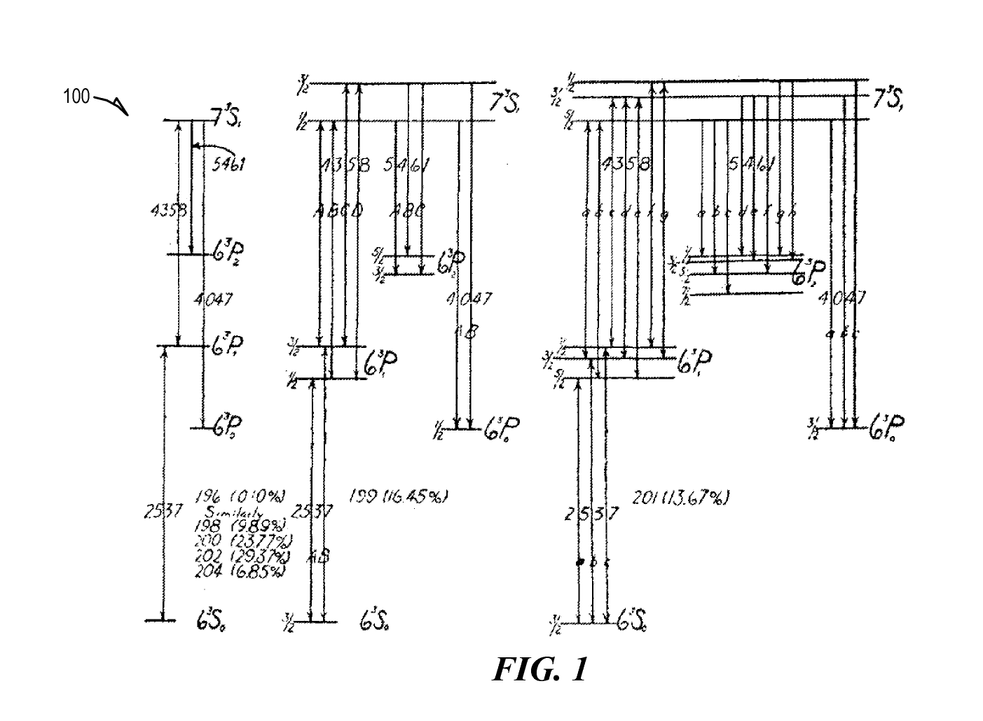

FIG. 1 illustrates generally an example 100 of an energy level diagram for various isotopic forms of mercury (Hg). Values such as 196, 198, 199, 200, 202, and 204 refer to the atomic mass numbers of the various isotopic forms. The percentage following each number includes a percent abundance of each form to be detected. Elemental Hg has an intense electronic transition at about 254 nm that excites ground state Hg atoms (in the ¹S₀ state) to one of the spin orbit states of the lowest excited electronic state, e.g., ¹S₀->³P₁ excitation. While this transition is “spin forbidden,” spin-orbit coupling is sufficiently strong in the heavy atom, Hg, that this transition has a radiative lifetime of about 120 nanoseconds (ns). Emission on this transition dominates the light generated by a low pressure Hg lamp. 1767 cm⁻¹ below the ³P₁ state of Hg, lies the ³P₀ state, the lowest electronically excited state, which cannot decay radiatively to the ground state and thus is long lived.

Collision of Hg atoms with most other atoms and molecules will quench the 254 nm emission by transfer of the population in the ³P₁ state to other, lower lying states. In most cases, the transfer to the ³P₀ state dominates, so most of the population initially in the ³P₁ state flows back into the ³P₀ state. The collisional relaxation of the ³P₀ is much slower, so under optical (e.g., UV) excitation at about 254 nm, a sizable fraction of Hg atoms exist in the ³P₁ state, and this population will be proportional to the total Hg concentration in the sample, as long as that concentration is sufficiently low that Hg-Hg collisions can be neglected, such as it is at Hg concentration levels that can be of interest for trace vapor monitoring, for example.

In other approaches, electric discharge such as microwave plasma can be used to excite Hg atoms. However, unlike the optically-excited approach described above, such electric discharge can also produce de-excitation and does not provide the desirable combination of optical excitation plus collisional relaxation to the ³P₀ state, unlike optical excitation. Accordingly, it is believed that microwave plasma or other electric discharge for excitation will not provide the same level of sensitivity and the same proportional level of ³P₀ excited-atoms, as compared to using optical excitation, such as provided by a low pressure UV lamp according to various examples described herein.

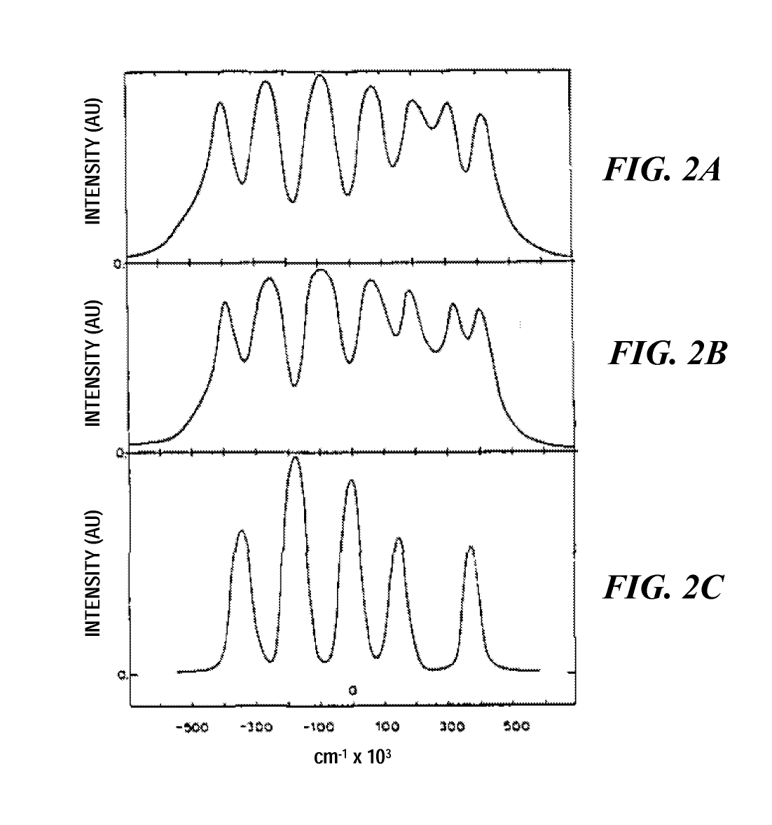

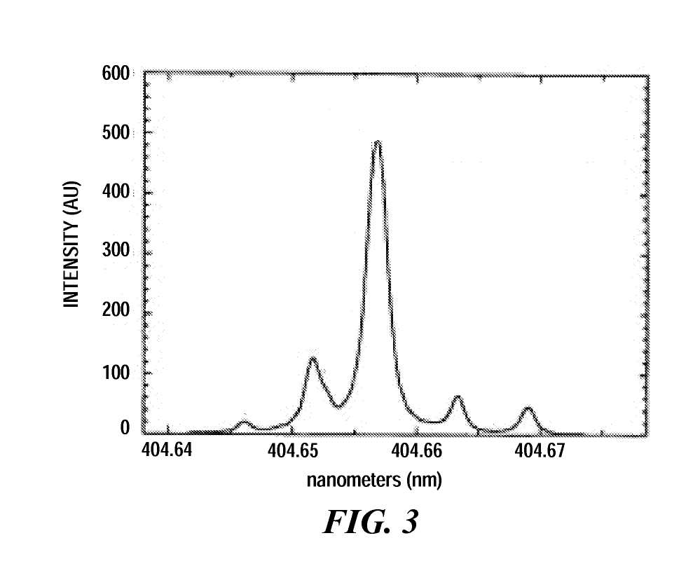

FIGS. 2A through 2C illustrates generally shapes of emission spectra of mercury centered around 253.7 nanometers (nm) that can be obtained from a discharge, such as from a reversed lamp in FIGS. 2A and 2B, and an un-reversed lamp in FIG. 2C. FIGS. 2A through 2C illustrate that a low pressure mercury vapor lamp can be used to provide ultraviolet optical excitation of mercury vapor that may be included in an analyte gas sample. Such optical excitation, in combination with collisional relaxation, can provide a substantial proportion of mercury atoms excited to the ³P₀ metastable state from the ground state. Also, a comparison between the examples of FIGS. 2A through 2C, and by contrast, FIG. 3, shows that the expected absorption spectrum of excited mercury (as shown in FIG. 3) is less complex (e.g., such an absorption spectrum has less fine structure) and is also less likely to be confounded by nearby absorption peaks from other species. The unreversed lamp configuration can allow for more efficient pumping of mercury atoms, however such pumping does still occur for a reversed lamp configuration.

FIG. 3 illustrates generally a shape of a absorption spectrum of mercury showing a range of peaks from about 404.65 nanometers (nm) to about 404.67 nanometers (nm), such as corresponding to a ³P₀→³S₁ energy level transition. The ³P₀ state has its lowest electronic transition, ³P₀→³S₁ at about 404.6565 nm. This transition has a radiative lifetime of 47 ns, and its absorption cross section (e.g., at the Doppler resolution limit) is about 4×10⁻¹² cm², about 7 times larger than that of the 254 nm absorption line that is generally used for Hg detection. Further, this transition has reduced hyperfine and mass dependent structure, as mentioned above, in comparison to the 254 nm absorption line. At this wavelength, external cavity, cw-diode lasers (ECDL) are presently available and can be used as an excitation source for cw-CRDS detection, for example. The absorption spectrum shown in FIG. 3 does not exist in Hg without prior excitation, such as optical excitation provided using a low pressure Hg lamp.

Also, the units in FIGS. 2A through 2C differ from the units shown in FIG. 3. In FIGS. 2A through 2C, the horizontal axis is defined as 1000 times a deviation of the wavenumber (e.g., an inverse of the vacuum wavelength in units of 1/centimeter or cm⁻¹). In FIG. 3, the horizontal axis is specified in terms of wavelength (in nanometers). Accordingly, while the scales between FIGS. 2A through 2C and FIG. 3 look similar at a glance, FIG. 3 includes a central absorption feature that is about ten times narrower than the width of the feature shown in, for example, FIG. 2A (e.g., about 1 cm⁻¹ in FIG. 2A versus about 0.1 cm⁻¹ in FIG. 3, if the feature widths are converted into inverse centimeters for comparison).

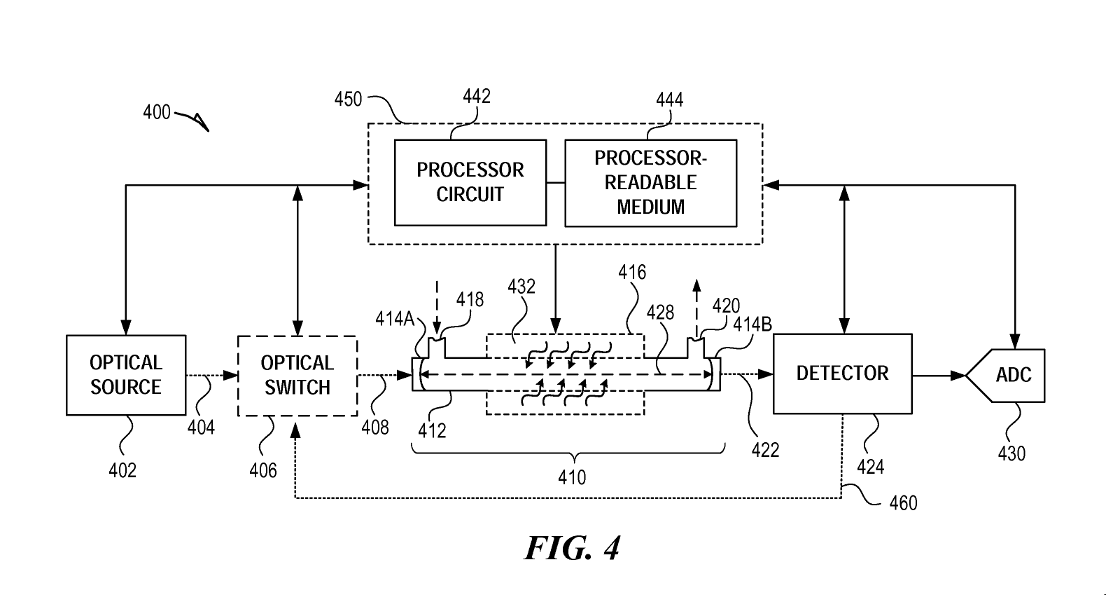

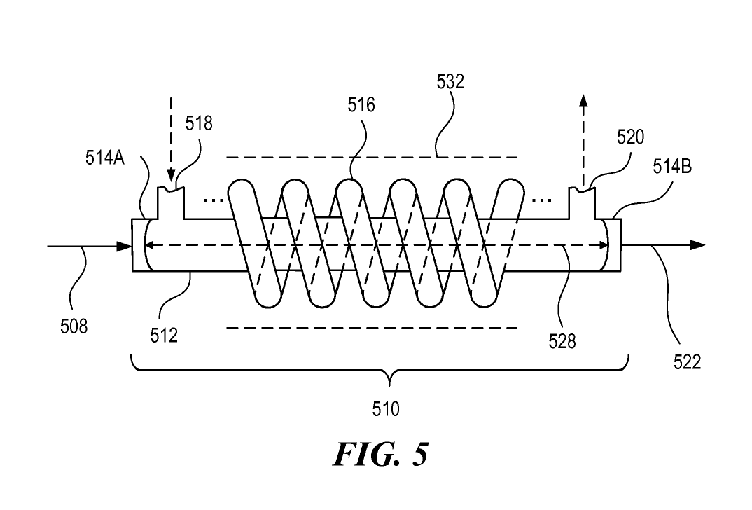

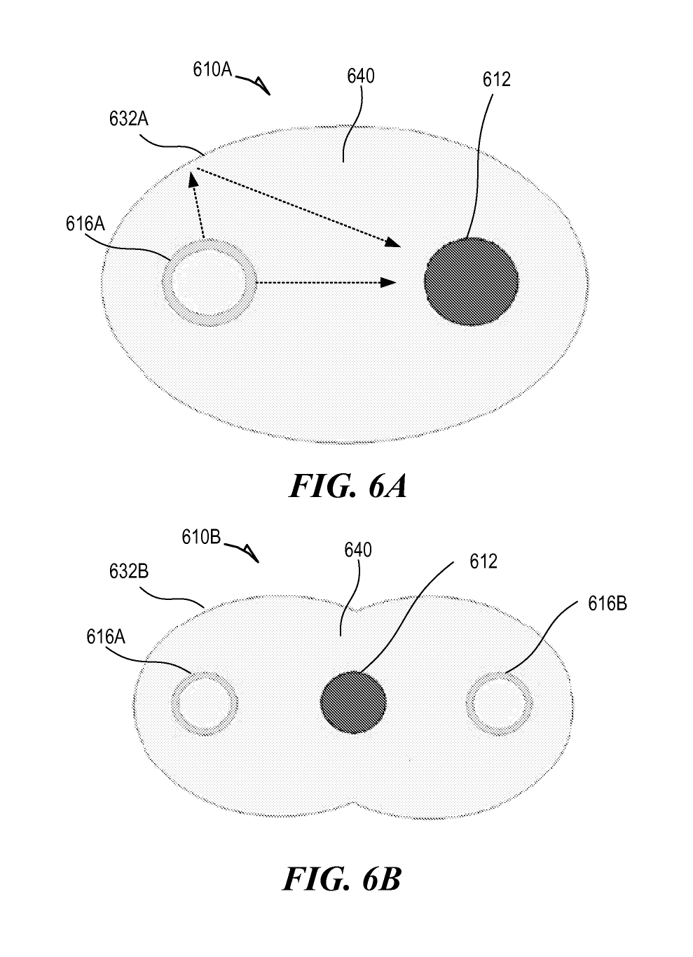

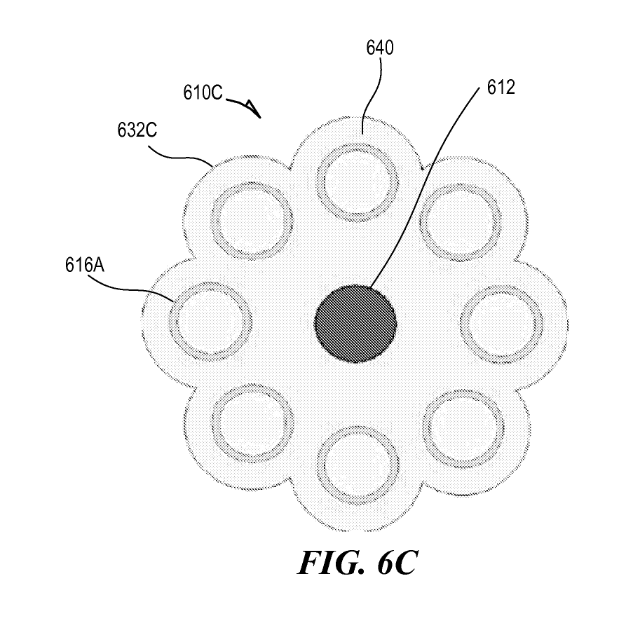

FIG. 4 illustrates generally an apparatus 400, such as a portion of a system that can be used for cavity ring-down spectroscopy (CRDS). The apparatus 400 can include an optical source 402, a sample cell assembly 410 including a source of optical excitation 416, and a detector 424. In the apparatus of FIG. 4, the source of optical excitation 416 can be referred to as a pre-excitation source. For example, as shown in FIGS. 5 and 6A through 6C, such a pre-excitation source can include a lamp assembly aligned with an optically-transmissive portion of a sample cell 412 or the lamp assembly can otherwise configured to couple optical energy to an analyte gas located in the sample cell 412, such as to excite a species included in the sample cell 412. An interior portion 432 of the source of optical excitation 416 can be filled with circulating or stagnant liquid or gas, such as to aid in cooling one or more lamps included as a portion of the source of optical excitation 416.

The sample cell 412 can include an inlet port 418, and an exit port 420, such as to couple the analyte gas to the sample cell 412. As mentioned elsewhere, the pressure of the analyte gas can be specified depending on the measurement objectives, such as including a partial pressure below atmospheric pressure. The sample cell 412 can include a first optical reflector 414A, and a second optical reflector 414B, such as to provide a high-finesse optically-resonant cavity. For example, the optical reflectors 414A and 414B can be confocally-arranged. The optical source 402 can be a continuous wave or pulsed optical source, such as a laser. For example, an external cavity diode laser (ECDL) can be used, and can be optically coupled to the sample cell 412 such as using an optical coupling 404 or 408. The optical source 402 can be tunable, and can be calibrated, such as locked to a separate reference cell or calibrated using a reference analyte including a specified concentration of a species with one or more known absorption peaks.

If a continuous wave source is used for the optical source 402, an optical switch 406 such as an acousto-optic modulator can be used such as to provide pulse optical energy to an optical coupling 408 leading to the sample cell 412. One or more of the optical couplings 404, 408, or 422 along the optical path to and beyond the sample cell 412 can include free-space couplings, fiber optic elements, fiber plate elements, or fiber bundle elements, or other optical devices such as focusing, collimating, or filtering optics. Optical energy provided by the optical source 402 can be tuned, or the cavity geometry of the sample cell 412 can be adjusted, such as to achieve resonance of optical energy 428 within the cavity. With each round-trip reflection of the optical energy 428 within the cavity, an amplitude of the outcoupled energy at the optical coupling 422 can decrease, providing a “ring-down” characteristic that can be detected using the optical detector 424.

The detector 424 can include a photodiode, a photomultiplier tube (PMT) or other device that can convert outcoupled optical energy from the sample cell 412 to an electrical signal. For example, a time-domain response (e.g., a cavity “ring-down” characteristic) or other electrical signal representative of an intensity envelope of outcoupled optical energy from the sample cell 412 can be digitized, such as using an analog-to-digital converter (ADC) circuit 430. Other signal conditioning, such as amplification or filtering can be performed either in the analog domain between the detector 424 and the ADC circuit 430, or in the digital domain, such as using a controller 450 including at least one processor circuit 442, and a processor-readable medium 444 (e.g., a non-transitory computer-readable storage medium). The controller 450 can be coupled to other portions of the apparatus, such as to perform one or more techniques described above or below. For reduction of latency, or to reduce a processing load on the at least one processor circuit 442, hardware triggering can be used between portions of the apparatus 400. For example, a hardware trigger 460 can be used to trigger the optical switch to extinguish coupling of the optical energy from the optical source 402, such as when outcoupled optical energy from the sample cell 412 exceeds a specified threshold. Other configurations are also possible. The sample cell 412 need not be a linear or cylindrical cell. For example, a ring laser cavity can be used while otherwise preserving other aspects of the examples herein.

In an illustrative example, the optical source 402 (e.g., a laser) and reflectors 414A and 414B can be specified for optimum performance in a blue region of the electromagnetic spectrum, such as for use in detecting a decay rate or duration related to absorption around at around 405 nm as mentioned elsewhere. The sample cell 412 can include a portion transparent to optical energy in a range of wavelengths of interest, such as in the ultraviolet range. For example, the sample cell 412 can include a fused silica or fused quartz cell body and the source of optical excitation 416 can include a low-pressure Hg lamp to excite the Hg atoms through an optically transmissive wall of the sample cell 412.

Based upon the intensity available from commercially-available low pressure Hg lamps, it is believed that an Hg pumping ¹S₀→³P₁ rate of about 10⁴ times per second can be provided. The pressure in the sample cell 412 can be adjusted, such as to increase or maximize the density of Hg atoms in the metastable ³P₀ state. As an illustration, without being bound by theory, an absolute pressure in the range of about 1 to about 100 torr can be used, such as depending on the principle components of the gas matrix, and it is believed that between 1-10% of the Hg atoms will be in the metastable state after excitation using the source of optical excitation 416.

A difference in cavity decay rates can be rapidly determined, such as by performing a measurement cycle using pre-excitation from the source of optical excitation 416, and then measuring a decay rate using probe light provided by the optical source 402, as compared to measuring a decay rate using probe light provided by the optical source 402, but without pre-excitation. In this manner, a baseline decay rate can be obtained, which will not include an absorption contribution from the metastable levels, because such levels have not be pre-excited in the latter case.

The pressure of the analyte gas within the cell can be regulated, such as to provide a stable or deterministic fractional production of the metastable state of the species to be probed, such as mercury. Such regulation can be performed using a pressure controller. In addition, or alternatively, a known amount or volumetric fraction of the species to be probed can be intentionally injected into the gas stream to provide a reference level for calibration or validation of performance, such as using a permutation tube and mass flow controller. A pressure of the analyte gas or other operational conditions can be adjusted using information about the known amount of the reference gas being injected, such as to provide a predictable correlation between fractional production of the metastable state and a corresponding level estimated using the pre-excitation techniques described herein. In one approach, a concentration of the fractional production of the metastable state can be monitored, such as using information about a transmission of the optically-resonant cavity (e.g., using apparatus or techniques such as Cavity-Enhanced Absorption Spectroscopy (CEAS)).

In an example, an oven or other energy source can be used such as to reduce oxidized mercury in the analyte gas stream to an elemental state for use with the optical excitation approaches described herein.

FIG. 5 illustrates generally an illustrative example of a portion of a sample cell assembly 510 that can include a helical optical energy source 516 (e.g., a helical low pressure mercury lamp) or other configuration, such as circumferentially located around a perimeter of an optically-transmissive portion of a sample cell 512. In an example, an electrical discharge into the optical energy source 516 an provide an intense emission of light, such as including a first range of wavelengths including a free space wavelength of about 254 nm.

As in the examples of FIGS. 4, 6A through 6C, and 7, an analyte gas, provided to the sample cell 512 using an inlet port 518, can include a species such as mercury vapor, that can be excited using the first range of wavelengths. The analyte gas can be discharged from the sample cell using an outlet port 520. After excitation using the helical optical energy source 516, probe light 508 can be coupled to the sample cell 512. A first reflector 514A and a second reflector 514B can be arranged to provide a high-finesse optically-resonant cavity. The probe light 508 can include a second range of wavelengths, such as different from the first range of wavelengths. For example, the second range of wavelengths can include optical energy having a free space wavelength of about 404.66 nm. One or more of a cavity geometry of the sample cell 512 (e.g., a length) or an output wavelength of a source of the probe light 508 can be adjusted such as to provide operation on a resonance of the optical cavity.

Optical energy 528 within the cavity can traverse the round trip distance between the reflectors 514A and 514B to provide a ring-down characteristic that can be detected in outcoupled optical energy 522. As mentioned elsewhere, using probe light at 404.66 nm will elicit an absorption peak for mercury after pre-excitation, where the pre-excitation can induce an excited metastable energy level in a proportion of the mercury atoms, when mercury is present. In this manner, a presence or level of mercury in the analyte gas can be detected. In an example, a housing 532 for the helical source of optical energy 516 can include a reflective portion, such as to focus the excitation energy toward to sample cell 512.

FIGS. 6A through 6C illustrate generally illustrative examples of cross-sectional views of a portion of a sample cell assembly that can include one or more linearly-arranged optical energy sources. As in the examples of FIGS. 4, 5, and 7, the sample cell configurations shown in FIGS. 6A through 6C can be used, such as for trace detection of a species, (e.g., mercury) in an analyte gas. One or more lamps, such as a low pressure mercury vapor lamp 616A or 616B can be arranged to provide optical energy to a sample cell 612. As mentioned in relation to other examples, the sample cell 612 can include a transmissive wall to permit coupling of optical energy from the mercury vapor lamp 616A or 616B to the sample cell 612.

In an example, the long axis of the linear lamps 616A or 616B can be aligned with a long axis of the sample cell 612. In the examples of FIGS. 6A through 6C, a housing 632A can include a reflective portion (either the housing material itself can be reflective, or it can be clad with a reflective material, such as to reflect ultraviolet radiation). The housing 632A can include an elliptical cross section, such as to focus optical energy emitted by the lamp 616A on the sample cell 612. Other configurations can be used, such as a combination of multiple ellipses as shown in the examples of FIG. 6B or 6C, or other reflector configurations, such as configured to focus or collimate optical energy from one or more lamps 616A or 616B to be provided to the sample cell 612. In FIG. 6B, a double-ellipse housing 632B is shown, with two lamps 616A and 616B. In FIG. 6C, a multi-ellipse housing 632C is shown, with multiple lamps. The combination of the housing and lamps can be referred to as a pumping geometry. An interior region 640 of the housings 632A through 632C can form a cavity, such as to contain a cooling medium. The cooling medium can include a circulating fluid, such as water, or air, for example.

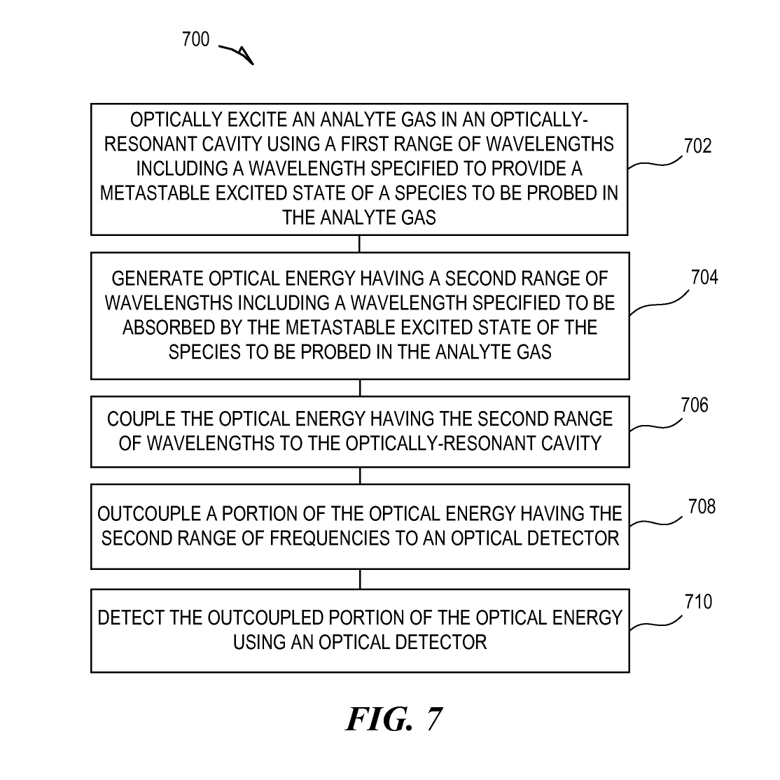

FIG. 7 illustrates generally a technique 700, such as a method. At 702, the technique 700 can include optically exciting a species included in an analyte gas located in a resonant cavity, such as using a first range of wavelengths including a wavelength specified to provide a metastable exited state of a species to be probed in the analyte gas. At 704, optical energy can be generated, such as using a laser (e.g., a diode laser) having a second range of wavelengths, including a wavelength specified to be absorbed by the metastable excited state of the species to be probed in the analyte gas.

At 706, the generated optical energy having the second range of wavelengths can be optically coupled to an optically resonant cavity. For example, the optically resonant cavity can include a sample cell as shown and described in other examples herein. Such optical energy can be coupled using free-space coupling, or, for example, using fiber optic techniques or using some other form of optical waveguide. Such coupled optical energy in the second range of wavelengths can reflect repeatedly between reflectors included as a portion of the optically-resonant cavity, such as to probe the analyte gas within the cavity. At 708, a portion of the optical energy having the second range of frequencies can be outcoupled to an optical detector. For example, the intensity profile of the outcoupled optical energy can include a decaying intensity versus time, such as after a pulse of optical energy is coupled to the optically-resonant cavity, or after the optical energy or resonant cavity are swept through a resonance of the cavity. Such a decaying intensity can include a decay rate or duration indicative of a presence or quantity of a target species, such as mercury vapor, in the analyte gas. The detector output can be processed, such as electronically in the analog or digital domain, such as to determine a rate of radiation loss inside the cavity. Such a rate of radiation loss is generally proportional to the mercury concentration inside the cell. A mercury concentration can then be estimated.

### ADDITIONAL NOTES

Each of the non-limiting examples described in this document can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method, comprising:
optically exciting an analyte gas in an optically-resonant cavity using optical energy having a first range of wavelengths including a wavelength specified to provide a metastable excited state of a species to be probed in the analyte gas;
generating optical energy having a second range of wavelengths including a wavelength specified to be absorbed by the metastable excited state of the species to be probed in the analyte gas;
coupling the optical energy having the second range of wavelengths to the optically-resonant cavity;
outcoupling a portion of the optical energy having the second range of wavelengths from the optically-resonant cavity to an optical detector; and
detecting the outcoupled portion of the optical energy using an optical detector.

2. The method of claim 1, comprising:
determining one or more of a decay rate or a decay duration of outcoupled optical energy, the outcoupled optical energy include a range of wavelengths corresponding to a resonance of the optical cavity; and
determining a concentration of the species in the analyte gas using information about one or more of the decay rate or decay duration.

3-4. (canceled)

5. The method of claim 1, wherein generating the optical energy having the second range of wavelengths includes using a continuous wave source and an optical switch to time-gate an output of the continuous wave source to provide the pulsed optical energy.

6. (canceled)

7. The method of claim 1, comprising adjusting one or more of a length of the optically-resonant cavity or adjusting the second range of wavelengths to provide excitation sweeping on and off a resonance of the optically-resonant cavity.

8. (canceled)

9. The method of claim 8, wherein the species includes mercury.

10. (canceled)

11. The method of claim 1, comprising
detecting an outcoupled portion of the optical energy using the optical detector to obtain a baseline response in the absence the metastable excited state of the species.

12. The method of claim 1, wherein the optically-resonant cavity includes a portion that is transparent to optical energy in the first range of wavelengths; and
wherein generating the optical energy including the first range of wavelengths includes using an ultraviolet-emitting lamp.

13. The method of claim 12, wherein the ultraviolet-emitting lamp is helically located around a circumference of a portion of the optically-resonant cavity.

14. The method of claim 12, wherein the ultraviolet-emitting lamp includes a linear lamp configuration with a longitudinal axis of the lamp located parallel to a longitudinal axis of the optically-resonant cavity.

15. The method of claim 14, the ultraviolet-emitting lamp is housed using a housing including a reflector configured to reflect optical energy emitted by the lamp toward the resonant cavity;
wherein the housing includes an elliptically-shaped portion;
wherein the ultraviolet-emitting lamp is located at a first focus of the elliptically-shaped portion; and
wherein the optically-resonant cavity is located at a second focus of the elliptically-shaped portion.

16. (canceled)

17. A system, comprising:
an optically-resonant cavity configured to receive an analyte gas;
a first optical source optically coupled to the optically-resonant cavity and configured to excite the analyte gas using a first range of wavelengths including a wavelength specified to provide a metastable excited state of a species to be probed in the analyte gas;
a second optical source configured to generate optical energy having a second range of wavelengths including a wavelength specified to be absorbed by the metastable excited state of the species to be probed in the analyte gas; and
an optical detector configured to detect an outcoupled portion of the optical energy from the optically-resonant cavity.

18. The system of claim 17, comprising:
an analog-to-digital converter circuit coupled to the optical detector;
a controller including a processor circuit and a processor-readable medium, the controller coupled to the analog-to-digital converter and configured to obtain digital information indicative of the detected outcoupled portion of the optical energy from the optically-resonant cavity, provided by the optical detector; wherein the processor-readable medium includes instructions that, when performed by the processor circuit, cause the system to:
determine one or more of a decay rate or a decay duration of outcoupled optical energy, the outcoupled optical energy include a range of wavelengths corresponding to a resonance of the optical cavity; and
determine a concentration of the species in the analyte gas using information about one or more of the decay rate or decay duration.

19-20. (canceled)

21. The system of claim 17, where the second optical source includes a continuous wave source; and
wherein the system includes an optical switch to time-gate an output of the continuous wave source to provide pulsed optical energy.

22. (canceled)

23. The system of claim 17, wherein one or more of the optically-resonant cavity or the second optical source is adjustable to provide cavity excitation sweeping on and off a resonance of the optically-resonant cavity.

24. (canceled)

25. The system of claim 17, wherein the species includes mercury.

26. (canceled)

27. The system of claim 17, wherein the optically-resonant cavity includes a portion that is transparent to optical energy in the first range of wavelengths; and
wherein the first optical source includes an ultraviolet-emitting lamp.

28. The system of claim 27, wherein the ultraviolet-emitting lamp is helically located around a circumference of a portion of the optically-resonant cavity.

29. The system of claim 27, wherein the ultraviolet-emitting lamp includes a linear lamp configuration with a longitudinal axis of the lamp located parallel to a longitudinal axis of the optically-resonant cavity.

30. The system of claim 29, comprising a housing including a reflector configured to house the ultraviolet-emitting lamp and configured to reflect optical energy emitted by the lamp toward the resonant cavity;
wherein the housing includes an elliptically-shaped portion;
wherein the ultraviolet-emitting lamp is located at a first focus of the elliptically-shaped portion; and
wherein the optically-resonant cavity is located at a second focus of the elliptically-shaped portion.

31. (canceled)

32. A system, comprising:
an optically-resonant cavity configured to receive an analyte gas;
a first optical source optically coupled to the optically-resonant cavity and configured to excite the analyte gas using a first range of wavelengths including a wavelength specified to provide a metastable excited state of a species to be probed in the analyte gas;
a second optical source configured to generate optical energy having a second range of wavelengths including a wavelength specified to be absorbed by the metastable excited state of the species to be probed in the analyte gas;
an optical detector configured to detect an outcoupled portion of the optical energy from the optically-resonant cavity;
an analog-to-digital converter circuit coupled to the optical detector; and
a controller including a processor circuit and a processor-readable medium, the controller coupled to the analog-to-digital converter and configured to obtain digital information indicative of the detected outcoupled portion of the optical energy from the optically-resonant cavity, provided by the optical detector; wherein the processor-readable medium includes instructions that, when performed by the processor circuit, cause the system to:
determine one or more of a decay rate or a decay duration of outcoupled optical energy, the outcoupled optical energy include a range of wavelengths corresponding to a resonance of the optical cavity; and
determine a concentration of the species in the analyte gas using information about one or more of the decay rate or decay duration;
wherein the optically-resonant cavity includes a portion that is transparent to optical energy in the first range of wavelengths;
wherein the first optical source includes an ultraviolet-emitting lamp;
wherein the first range of wavelengths includes a wavelength corresponding to an energy level transition from a ground state to a metastable state of the species to be probed in the analyte gas; and
wherein the species includes mercury.
